(19) United States
(12) Patent Application Publication
(10) Pub. No.: US 2005/0002427 A1
(43) Pub. Date: Jan. 6, 2005

(54) Cooled electrodes for high repetition excimer or molecular fluorine lasers

(76) Inventors: Igor Bragin, Goettingen (DE); Vadim Berger, Goettingen (DE); Ulrich Rebhan, Goettingen (DE); Norbert Niemoller, Ebergoetzen (DE); Konstantin Aab, Kassel (DE)

Correspondence Address: STALLMAN & POLLOCK LLP, SUITE 2200, 353 SACRAMENTO STREET, SAN FRANCISCO, CA, 94111, US

(21) Appl. No.: 10/833,455

(22) Filed: Apr. 28, 2004

Related U.S. Application Data
(60) Provisional application No. 60/473,758, filed on May 28, 2003.
(60) Provisional application No. 60/486,069, filed on Jul. 10, 2003.

(51) Int. Cl. H01S 3/04; H01S 3/22; H01S 3/223

(52) U.S. Cl. 372/35; 372/57; 372/55

(57) ABSTRACT

The consumption and/or erosion of electrodes in high repetition rate gas discharge lasers, such as excimer or molecular fluorine lasers, can be reduced using any of a number of temperature regulation approaches described herein. A flow of a cooling medium can be used to remove heat from the electrodes during laser operation, in order to reduce the rate of consumption and/or erosion. The rate of erosion can be controlled by adjusting the rate and/or temperature of the cooling medium flowing through the electrodes, or in bodies in good thermal contact with those electrodes. The cooled electrodes also can function to remove heat from the laser gas, and can have finned surfaces to facilitate such heat removal. Regulating the temperature of the electrodes and laser gas also can function to minimize resonance effects in the laser gas due to the presence of temperature gradients.

### CLAIM OF PRIORITY

This application claims priority to U.S. Provisional Patent Application No. 60/473,758, entitled “COOLED ELECTRODES FOR HIGH REPETITION EXCIMER OR MOLECULAR FLUORINE LASERS,” to Igor Bragin, et al., filed May 28, 2003; as well as U.S. Provisional Patent Application No. 60/486,069, entitled “COOLED ELECTRODES FOR HIGH REPETITION EXCIMER OR MOLECULAR FLUORINE LASERS,” to Igor Bragin, et al., filed Jul. 10, 2003, each of which is hereby incorporated herein by reference.

### TECHNICAL FIELD OF THE INVENTION

The present invention relates to the temperature regulation of electrodes, such as may be useful for excimer or molecular fluorine lasers operated at high repetition rates.

### BACKGROUND

Gas discharge lasers such as line-narrowed and/or line-selected excimer and molecular fluorine lasers are advantageously used in industrial applications such as optical microlithography for forming small electronic structures on silicon substrates. Photoablation and micromachining applications typically require medium to high power lasers, which typically include a laser chamber containing two or more gases, such as a halogen gas and one more rare gases. KrF (248 nm) and ArF (193 nm) excimer lasers are examples of gas discharge lasers that are typically line-narrowed and that have gas mixtures, respectively, of krypton, fluorine, and a buffer gas typically of neon; and argon, fluorine, and a buffer gas of neon and/or helium. The molecular fluorine (F₂) laser has a gas mixture of fluorine and one or more buffer gases, and emits at least two lines around 157 nm. One of these lines can be selected and narrowed, such that a very narrow linewidth VUV beam is realized. The laser chamber contains electrodes which are spaced apart by about 12 mm for high repetition rate lasers, such as for example 6 kHz lasers. Further, a fan for circulating the laser gas between the electrodes is installed, as well as a heat exchanger for cooling the laser gas. A dust precipitator is used in the laser chamber to remove dust particles from the chamber. For high repetition rate lasers of 6 kHz and higher, the electrodes often experience a relatively short life time and tend to degrade laser performance.

### BRIEF DESCRIPTION OF THE DRAWINGS

FIG. 1(a) is a cross-section view of a laser chamber that can be used in accordance with various embodiments of the present invention.

FIG. 1(b) is a schematic diagram showing modules of a laser system that can be used with the chamber of FIG. 1(a).

FIG. 2 is a cross-section view of the laser chamber of FIG. 1(a) showing a cooling of the anode and cathode in accordance with one embodiment of the present invention.

FIG. 3 is a cross-section view of the laser chamber of FIG. 1(a) showing a cooling of the cathode by a separate, channeled cooling body in accordance with another embodiment of the present invention.

FIG. 4 is a cross-section view of the laser chamber of FIG. 1(a) showing a cooling of the cathode in accordance with another embodiment of the present invention.

FIG. 5 is a cross-section view of the laser chamber of FIG. 1(a) showing a cooling of the anode by a channeled cooling body in accordance with another embodiment of the present invention.

FIG. 6 is a cross-section view of the laser chamber of FIG. 1(a) showing a cooling of the anode in accordance with another embodiment of the present invention.

FIG. 7 is a cross-section view of the laser chamber of FIG. 1(a) showing a cooling of the anode and special shape of the anode in accordance with another embodiment of the present invention.

FIG. 8 is a cross-section view of the laser chamber of FIG. 1(a) showing a cooling of the anode and fins on the surface of the anode in accordance with another embodiment of the present invention.

FIG. 9 is a cross-section view of the laser chamber of FIG. 1(a) showing a fin structure of the anode in accordance with another embodiment of the present invention.

FIG. 10 is a cross-section view of the laser chamber of FIG. 1(a) showing cooling elements outside the laser chamber in accordance with another embodiment of the present invention.

FIG. 11 is a cross-section view of the laser chamber of FIG. 1(a) showing replacement of the heat exchanger by cooling plates in accordance with another embodiment of the present invention.

### DETAILED DESCRIPTION

Systems and methods in accordance with various embodiments of the present invention can overcome deficiencies in existing gas discharge laser systems by utilizing any of a number of temperature regulation approaches disclosed herein. For example, a laser chamber can have a pair of discharge electrodes that are “cooled” when the laser system is operating at repetition rates at or above about 4.0 kHz. As an electrode tends to increase in temperature during laser operation, “cooling” of an electrode as described herein can refer generally to any approach by which an amount of heat is removed from that electrode. For instance, an electrode can be said to be “cooled” if the electrode is only allowed to increase in temperature to 100° C., but is not allowed to increase beyond 100° C. due to an amount of heat removal from the electrode. The amount of heat removed can be varied in order to maintain the electrode at 100° C., or simply to ensure that the electrode does not exceed 100° C. In one embodiment, a control module can begin a flow of coolant through at least one channel in an electrode when the repetition rate of the laser nears, reaches, or exceeds about 4 kHz. Alternatively, the flow can remain constant but the control module might lower the temperature of the cooling media as the repetition rate nears, reaches, or exceeds about 4 kHz. Cooling of the electrodes can improve the life time of the electrodes while minimizing acoustic resonance effects inside the laser chamber. Several exemplary embodiments are disclosed herein which can be advantageous for differing systems and applications.

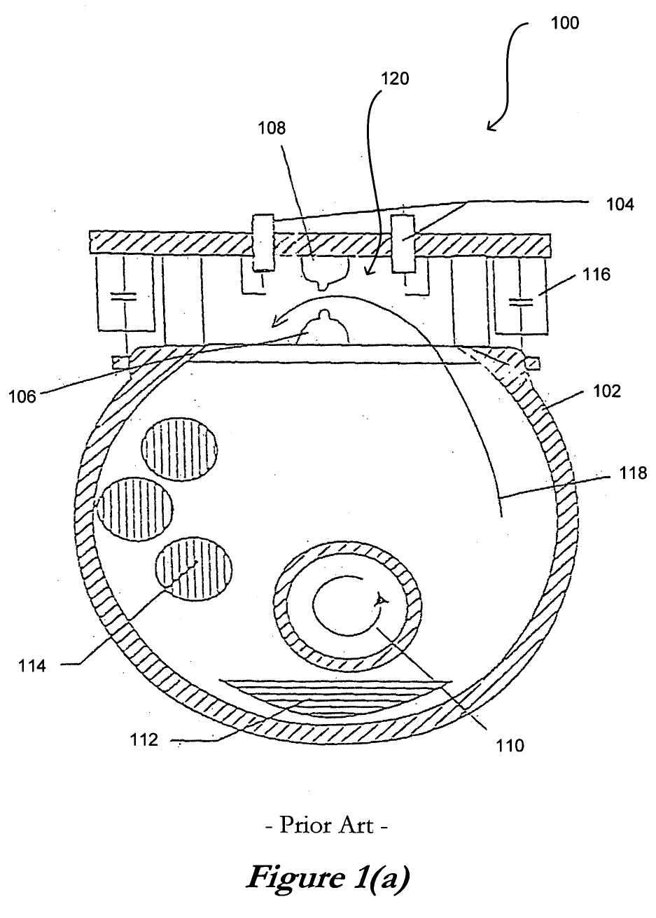

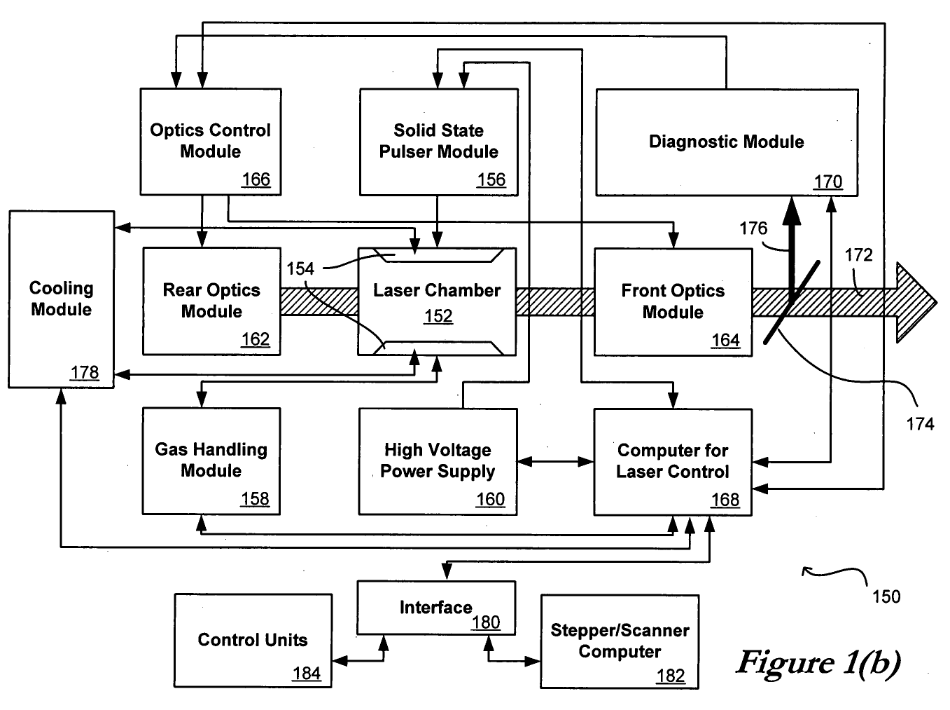

FIG. 1(a) shows a cross-section 100 of an exemplary discharge tube of the prior art, which can be used with various embodiments of the present invention. The cross-section shows elements of a typical gas discharge laser as would be known to one of ordinary skill in the art, including a laser chamber 102, a preionization unit 104 which can include a number of pre-ionization pins protruding into the laser chamber as known in the art, anode 106 and cathode 108 electrodes, a gas circulation fan 110, an electrostatic filter 112, a heat exchanger 114, and discharge capacitors 116. The direction of gas circulation in the laser chamber is indicated by reference line 118, which passes from a lower, laser gas portion of the laser chamber through a discharge region 120 between the anode 106 and cathode 108 electrodes

FIG. 1(b) shows a schematic overview of the modules of an exemplary laser system 150 that can be used in accordance with various embodiments of the present invention. The overall system includes a laser chamber 152 with a pair of discharge electrodes 154, such as is described with respect to FIG. 1(a). A solid-state/thyratron pulser module 156 and high voltage power supply 160 can be used to provide electrical energy in compressed electrical pulses to the preionization and main electrodes 154 in the laser chamber 152, in order to energize the gas mixture and generate an optical pulse in the chamber. Pulser components for both single and multiple chamber systems are described in pending U.S. patent application Ser. No. 10/776,137, entitled “EXCIMER OR MOLECULAR FLUORINE LASER WITH SEVERAL DISCHARGE CHAMBERS,” to Sergei V. Govorkov et al., filed Feb. 11, 2004, as well as pending U.S. patent application Ser. No. 10/699,763, entitled “EXCIMER OR MOLECULAR FLUORINE LASER SYSTEM WITH PRECISION TIMING,” to Dirk Basting et al, filed Nov. 3, 2003, both of which are hereby incorporated herein by reference. A processor 168, computer, or control module for the overall laser system can receive various inputs, such as a temperature from the cooling module, a drive signal from a stepper machine, and a status signal from the diagnostic module. In response to these and other inputs, as well as any programming or other data, the processor can control various operating parameters of the system. A diagnostic module 170 can receive and measure one or more parameters of the laser system, such as pulse energy, average energy, and power. The diagnostic module 170 also can measure the wavelength of a split-off portion 176 of the main beam 172. The split-off portion can be redirected by optics, such as a beam splitter 174, capable of deflecting a small portion 176 of the beam toward a detector of the diagnostic module 170. A resonator cavity can be defined by a front optics module 164 and rear optics module 162, disposed on either side of the laser chamber 152 containing the laser gas mixture, such that the overall resonator cavity would include the laser chamber as well as the front and rear optics modules.

In some embodiments a dual chamber system can be utilized, such as a MOPA system as is known in the art and as described in pending U.S. patent application Ser. No. 10/696,979, entitled “MASTER OSCILLATOR—POWER AMPLIFIER EXCIMER LASER SYSTEM,” to Gongxue Hua et al., filed Oct. 30, 2003, which is hereby incorporated herein by reference. MOPA technology can be used to separate the bandwidth and power generators of a laser system, as well as to separately control each gas laser chamber, such that both the required bandwidth and pulse energy parameters can be optimized. Using a master oscillator (MO), for example, an extremely tight spectrum can be generated for high-numerical-aperture lenses at low pulse energy. A power amplifier (PA), for example, can be used to intensify the light, in order to deliver the power levels necessary for the high throughput desired by the chip manufacturers. The MOPA concept can be used with any appropriate laser, such as KrF, ArF, and F₂-based lasers. Further, a MOPA system can utilize separate switch/pulser systems for each laser chamber (for the MO and the PA). In such a MOPA system, the optics modules can be positioned on either side of the master oscillator chamber, and can allow the resultant optical pulse to pass to the power amplifier.

One of the optics modules 162, 164 can include line-narrowing optics, which can be useful for applications such as photolithography. In other embodiments, the optics modules may simply include resonator mirrors for laser systems where line-narrowing is not desired, such as for TFT annealing applications, or where a spectral filter is used that is external to the resonator. For an F₂-laser, for example, optics can be used to select one of multiple lines around 157 nm.

An optics control module 166 can be used to control the front and rear optics modules, such as by receiving and interpreting signals from the processor 168 and initiating realignment, gas pressure adjustments, or reconfiguration procedures in response to those signals. The diagnostic module 170 can be a wavelength and/or bandwidth detection component such as a monitor etalon, energy detector, or grating spectrometer. A hollow cathode lamp or reference light source, for example, can be used to provide absolute wavelength calibration of such a monitor etalon or grating spectrometer. Halogen gas injections and gas replacement procedures, as known in the art, can be performed using a gas handling module 158, which can include a vacuum pump, a valve network, and one or more gas compartments. A laser control computer 168 can communicate through an interface 180 with a stepper/scanner computer 182, other control units 184, and/or other external systems.

A cooling module, as discussed elsewhere herein, can be in electrical communication with the processor 168, and can be in fluid communication with at least one channel in at least one of the electrodes 154, or bodies in thermal contact with those electrodes. The cooling module can receive a signal from a temperature sensor, or from a processor or system computer, indicating the current temperature of at least one of the electrodes, the laser gas, and/or the laser chamber, or an amount of temperature adjustment. The control module, in response to the temperature signal, can alter the cooling of the electrodes and/or laser chamber by altering a flow of cooling medium through the electrodes/chamber, such as by altering a temperature or flow rate of the medium. The control module can be in fluid communication with a pump (not shown) for creating the flow, and can be in fluid communication with a media reservoir (not shown) for storing and/or providing the cooling medium. A heat exchanger (not shown) or other temperature controlling mechanism also can be used to adjust the temperature of the cooling medium entering the electrodes/chamber.

In another embodiment, the cooling module can be replaced by a temperature control or temperature regulation module. Such a module can be in communication with a fluid temperature regulator, or a source of warm and cool fluids, in order to control a temperature of the medium flowing through the channels of the electrodes and/or additional bodies. If it is desirable to heat an electrode, for instance, such as at the beginning of a pulse cycle when the electrode is otherwise relatively cool, a heated fluid can be flowed through the channels in order to heat the electrode. The heating flow can be reduced once the pulsing begins, or once the electrode reaches a certain temperature. A cooling flow then can begin once the repetition rate reaches a certain level, or when the temperature of the electrode reaches a predetermined temperature. In such systems, the flow can be used to add or remove heat from the system, depending upon the state of the system.

Each laser chamber in the system can include at least a pair of electrodes for charging the laser gas. Each electrode can include an electrode body made of an appropriate material, such as brass, which can be desirable for 1-4 kHz lasers as well as high repetition rate lasers of 6 kHz and higher. Each electrode can have a ceramic spoiler (not shown) as described in pending U.S. patent application Ser. No. 10/727,718, entitled “SYSTEMS AND METHODS UTILIZING LASER DISCHARGE ELECTRODES WITH CERAMIC SPOILERS,” to Igor Bragin et al., filed Dec. 4, 2003, which is assigned to the same assignee as the present invention and is hereby incorporated herein by reference. The electrode body can have a “nose” portion on the order of 0.4-1.0 mm in width and 2-4 mm in height for 1-6 kHz lasers. Lasers with repetition rates of 6 kHz or higher can utilize a nose portion on the order of 1.0 mm or lower in width and about 2.0 mm in height. For lasers of 6 kHz and higher, the gap between the anode and cathode electrodes can be reduced, such as from about 16 mm to about 12 mm, in order to reach a stable discharge with well-defined laser parameters.

One problem with a chamber design such as is shown in FIG. 1(a) is that there tends to be a strong erosion or consumption of the electrodes when the laser is operated at repetition rates of about 6 kHz and above. Long, continuous operation at such rates can result in a reduction of the laser output, or a change in the laser beam parameters, due to electrode erosion. Electrode erosion also can lead to the shape of the discharge being increasingly non-uniform, such as a discharge that is wider, narrower, split, or in any other way distorted, such that the quality of the laser beam degrades over time.

One primary cause for the erosion or consumption of the electrodes is the physical sputtering caused by ions and electrons impinging upon the electrodes. In order to minimize the amount of sputtering, many systems utilize electrode materials having high melting points, high hardness values, and/or high conductivity values. Further, reactions of the electrode materials with halogens present in the laser chamber can contribute to the consumption or erosion of the electrodes. Where the reactivity with respect to the halogen gases is sufficiently small, the factors which affect the electrode erosion can include, for example, the resistance to the evaporation and dissipation (changes of the thermal characteristics with respect to melting point, boiling point, vapor pressure, etc.) due to sputtering of the electrodes. Another such factor is the mechanical resistance to the thermal fatigue resulting from localized temperature rise of the electrodes, such as is described in U.S. Pat. No. 5,187,716, which is hereby incorporated herein by reference.

Electrodes are typically designed under the assumption that the electrodes will be operating in a perfectly uniform electric field. The actual discharges within a gas discharge laser, however, are not perfectly uniform. For instance, during an initial period after the beginning of the discharge, the discharge can be somewhat concentrated near the region(s) of strongest electrical field. The portions of the electrodes corresponding to these regions are eroded more quickly, typically into forms corresponding to the actual distribution of the electric field. Experiments have shown, for at least one system, that the consumption or erosion of the anode is much stronger than for the cathode. This observation is reported, for example, in U.S. Pat. Nos. 6,560,263 B1 and 5,187,716, each of which is incorporated herein by reference, where it is disclosed that fluorine (F) anions can contribute substantially to the consumption of electrodes. Attempts to reduce the erosion of the electrodes are disclosed in Patent Application WO 03/023910 A2, which is hereby incorporated herein by reference.

Erosion of the electrode material also can result in the production of “dust” in the laser chamber. This dust can degrade the quality of the discharge, and can contaminate the laser gas. The dust also can collect on the windows of the laser chamber, reducing the output of the chamber and requiring a periodic cleaning and/or changing of the chamber windows. Reducing the erosion of the laser therefore also can lessen system downtime by extending the life of the laser gas as well as the time between cleanings or changing of the chamber windows. Heating of the electrodes also can increase the presence of temperature gradients in the laser chamber, which can cause resonance effects that influence the laser parameters.

Systems and methods in accordance with various embodiments of the present invention can overcome these and other deficiencies in existing high repetition rate gas discharge laser systems through a temperature regulation of at least one electrode in the laser system. Removing heat from at least one of the electrodes during laser operation can prolong the life of that electrode, and can provide for a more stable discharge. Reducing the erosion of the electrode(s) also can lower the amount of system downtime needed to replace laser gas and remove dust contamination. Several embodiments are described herein through which electrode cooling can be accomplished. Cooling approaches described herein may be discussed with respect to a single laser chamber for simplicity, but it should be understood that the cooling approaches discussed herein can be used equally as well in multiple chamber systems, such as MOPA systems, with each chamber using the same cooling approach, or with at least some chambers using a combination of mixing approaches discussed herein. For example, an oscillator chamber might require more or less cooling than an amplifier chamber in the same system, such that it might be more efficient to utilize different cooling approaches for each chamber.

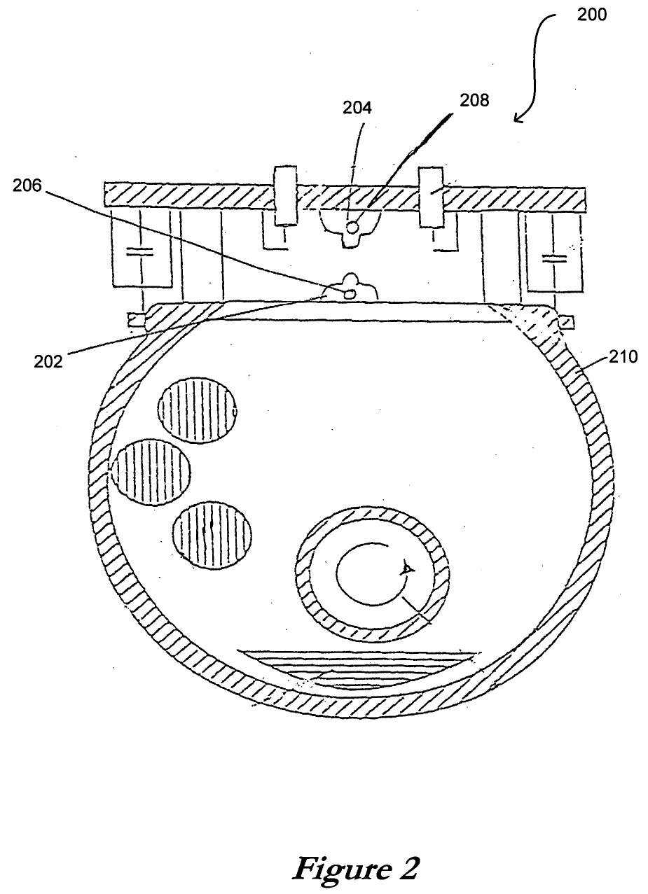

FIG. 2 shows a cooling approach 200 in accordance with a first embodiment of the present invention. In this embodiment, the electrodes 202, 204 in the discharge area of the laser chamber each have at least one channel, indicated by 206 and 208 respectively, located in the body of the electrode through which a cooling medium can flow. The flow of cooling medium through the channels can function to remove heat from the electrode bodies. The amount of heat removed can be controlled by the temperature of the cooling medium, the flow rate of the cooling medium, and the choice of cooling medium itself, such as a flow of water, or an appropriate oil or gas. The flow rates, cooling medium temperatures, and cooling media used can vary by application. The optimal combination can be determined for each system and/or application through routine experimentation as would be known to one of ordinary skill in the art. In one embodiment, water is used as a cooling medium and is controlled to be at a temperature in the range of 30-120° C., with a flow rate on the order of several liters per minute, in order to optimize the amount of heat removal. Each electrode can have multiple channels disposed in the body of the electrode. There can be a single flow to all of the channels, a separate flow for each channel, or a number of flows less than the number of channels. The location of the channels can be selected to maximize cooling while minimizing thermal gradients across the electrode. For example, in FIG. 2 the flow of gas between the electrodes would be from right to left through the discharge gap. In this case, the initial discharge might tend to push toward the left of the gap such that the left half of the electrode might tend to heat more than the right half. If this is the case, it might be beneficial to move the channel toward the left side of the electrode in the Figure, or increase the number and/or density of the channels toward that side of the electrode. If multiple flows are being directed through the electrode, it also might be beneficial to direct the coolest flow through the left side of the electrode.

Special fittings can be used in the case of multiple channels, in order to connect the channels with each other such that a single flow of cooling medium can be used. Not shown in FIG. 2 are tubes or piping which can be used to connect an inlet side of each channel and an outlet side of each channel to a cooling medium source (not shown) and/or drain located the outside of the laser chamber 210. The tubes can be connected via commercially available fittings to the channels of the electrodes. The connections can be brazed or welded connections, for example. Care should be taken during the assembly process to ensure the fittings are sufficiently tight, such that no leaks exist through which the cooling medium could enter the laser chamber. In embodiments where a closed cycle cooling system is used, a reservoir for the cooling medium can be used along with a pump to agitate the cooling medium in the cooling cycle.

Experiments have shown that, for a system in accordance with at least one embodiment, 2-3 kW of heat needs to be removed from the electrodes during laser operation at high repetition rates. It therefore can be desirable to optimize the size and location of the channels in the electrode, as well as the flow rate and temperature of the cooling medium flowing through those channels. For example, it can be desirable to place the cooling channels as close as possible to the electrode surface in order to maximize the amount of heat removal. The cooling medium also can be cooled before entering the channels of the electrodes, such as through use of a commercially available heat exchanger. In an embodiment wherein oil is used as the cooling medium, it is possible to reuse the oil from the pulser model to cool the electrodes. In laser systems where two or more electrode pairs are used, the channels of the anodes and the channels of the cathodes can be connected by fittings, or each electrode can be individually connected to the cooling medium. Tubes and fittings used to direct and contain the cooling medium can be selected from a group of materials that are resistant to halogens in the laser gas. Further, these additional components also are potential sources of contamination of the laser gases within the laser chamber. Contamination of the laser gases during the operation of an excimer laser can quench the laser action. Tubes and fittings inside of the laser chamber can be cleaned before use in the laser chamber in order to prevent contaminants such as hydrocarbons from being introduced into the laser chamber.

If the laser system is a multi-chamber system, one, some, or all of the laser chambers can include a flow of cooling medium through the electrodes, as described with respect to FIG. 2. In order to sufficiently cool the electrodes, it may be desirable to direct a separate flow of cooling medium to each chamber, as using the same flow can cause the medium be heated after each chamber. Alternatively, the system can utilize heat exchangers or other cooling methods to remove heat from the flow of cooling medium between chambers, such that a single flow can be used irregardless of the number of chambers in the system. In other systems, it may be advantageous to use different temperatures and/or cooling media with each chamber, in order to optimize operation of each chamber.

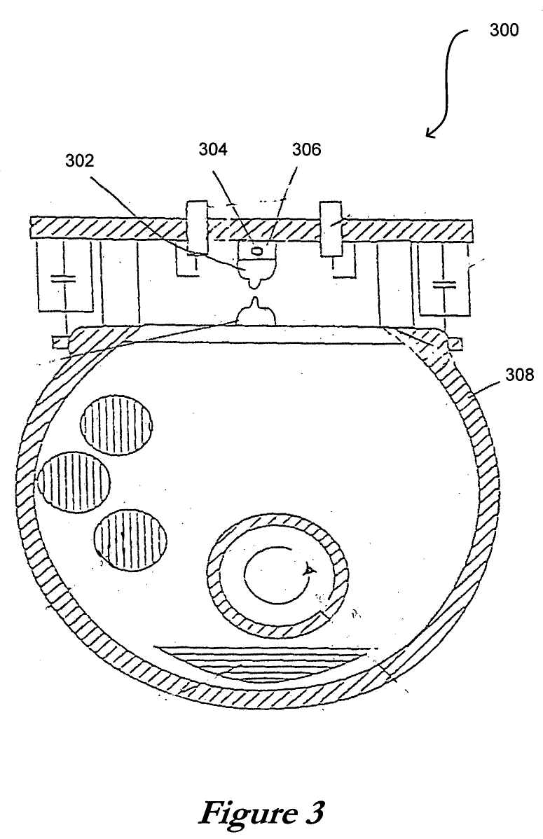

FIG. 3 shows a cooling approach 300 in accordance with a second embodiment of the present invention. In this embodiment only one of the electrodes, namely cathode 302, is cooled. The cathode is in contact with a separate, channeled cooling body 306 containing at least one channel 304 through which a flow of cooling medium can be directed in order to cool the channeled cooling body 306. Since the channeled cooling body is in good thermal contact with the cathode, the flow of cooling medium will function to remove heat from the cathode. The channeled cooling body 306 can be comprised of the same material as the electrode 302, or can be comprised of any suitable material with a sufficiently high thermal conductivity that is capable of being used in a gas discharge laser chamber. The cooling medium can be flowed into the channel(s) by tubes (not shown) going to the outside of the laser chamber 308. When using a separate, channeled cooling body with one of the electrodes, care should be taken to ensure that the proper discharge gap distance is left between the discharge electrodes. Care should also be taken to minimize any changes to the flow of laser gas in the chamber as a result of the channeled cooling body.

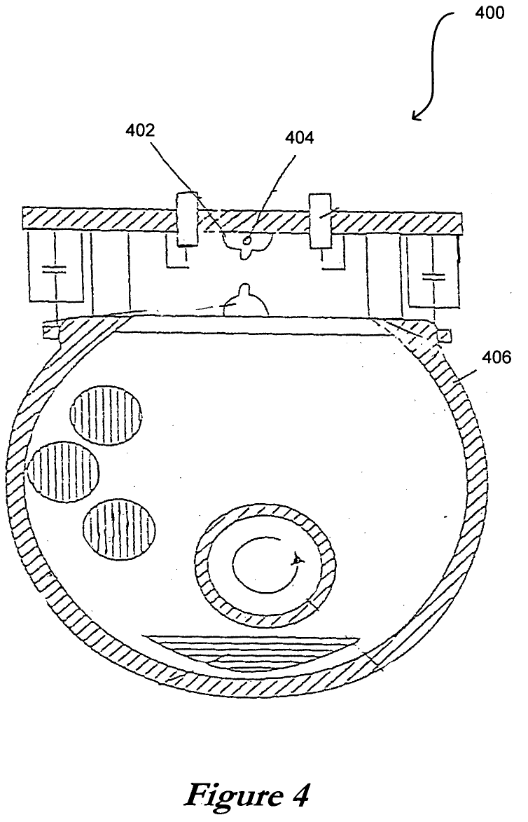

FIG. 4 shows a cooling approach 400 in accordance with a third embodiment of the present invention. This embodiment is similar to the approach described with respect to FIG. 2, except that only a single electrode, here the cathode 402, is cooled. The cooling medium can flow through at least one channel 404 in the body of the electrode. The cooling medium can be flowed into the channel(s) by tubes going to the outside of the laser chamber 406.

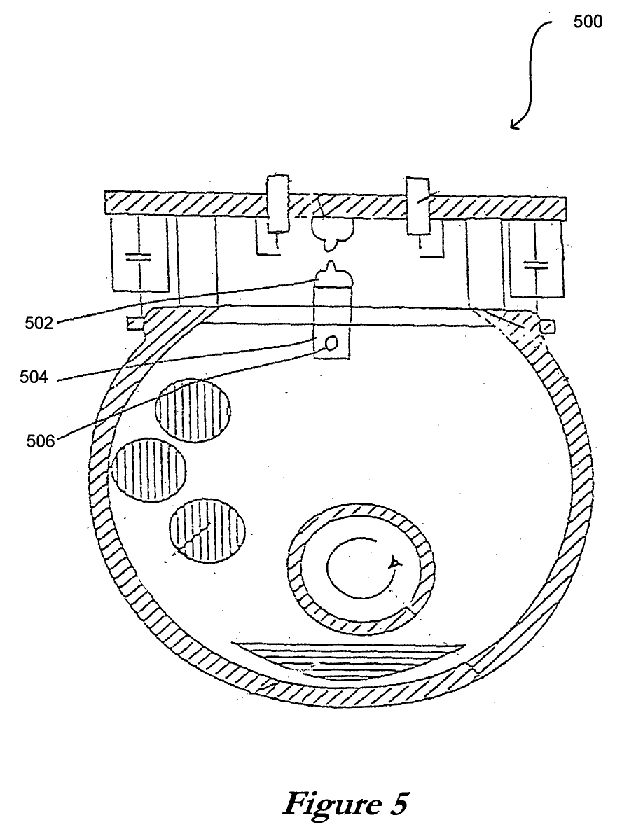

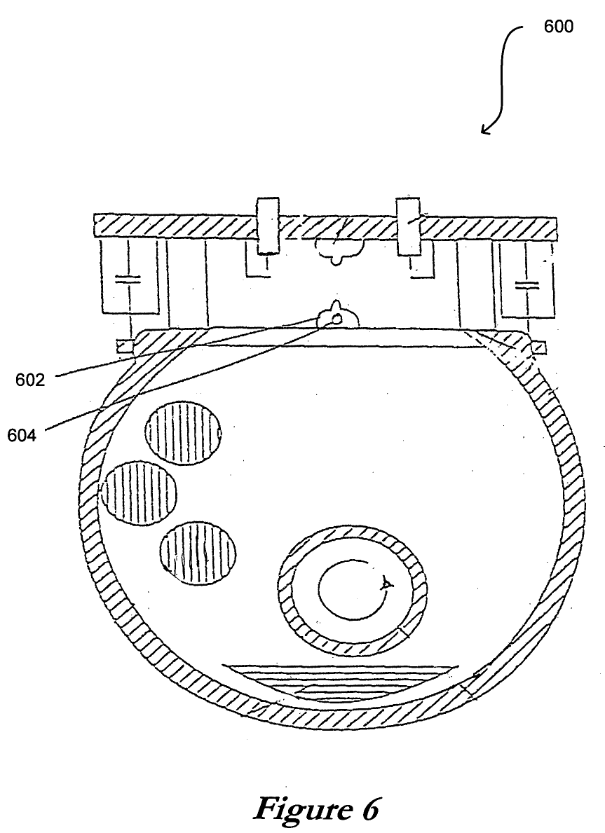

FIG. 5 shows a cooling approach 500 in accordance with a fourth embodiment of the present invention. This embodiment is similar to the approach described with respect to FIG. 3, in that a single electrode, here the anode 502, is cooled by a separate, channeled cooling body 504 in good thermal contact with the anode 502. The channeled cooling body 504 has at least one fluid channel 506 through which the cooling medium can flow. In this embodiment, however, the cooling channel is disposed away from the discharge gap and positioned inside the lower, laser gas portion of the laser chamber, wherein the laser gas passes through the heat exchanger and particulate filter as directed by the laser gas fan element. A flow of cooling medium through such a channel will still function to remove heat from the anode, as the channeled cooling body is in good thermal contact with the electrode, but also will function to cool the laser gas flowing through the lower portion of the laser chamber as directed by the fan element. FIG. 6 shows a cooling approach 600 in accordance with a fifth embodiment of the present invention. In this embodiment, a single electrode, here the anode 602, is cooled by directing a flow of cooling medium directly through the anode through one or more channels 604 as described with respect to FIG. 2. This embodiment can be used in place of the system in FIG. 5, for example, where simplicity is desired and it is not necessary to remove heat from the laser gas flowing through the laser chamber.

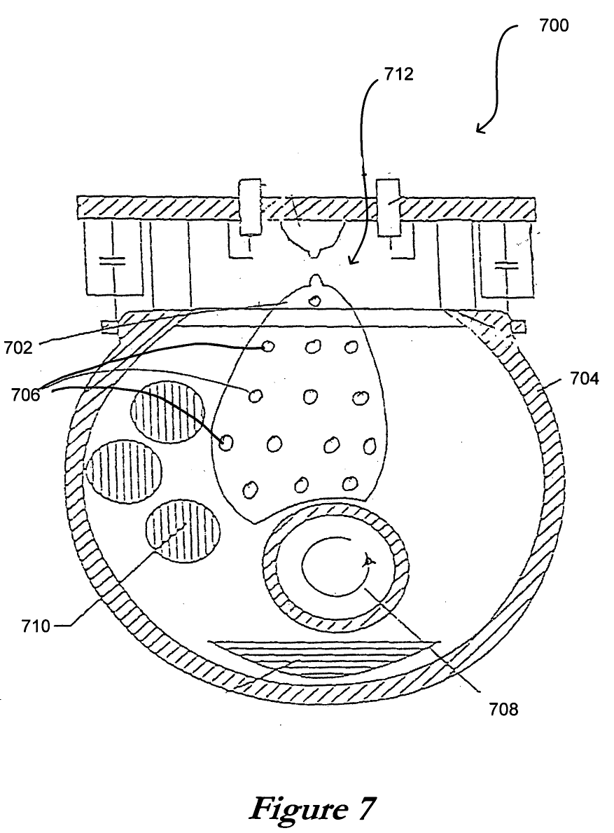

FIG. 7 shows a cooling approach 700 in accordance with a sixth embodiment of the present invention. In this embodiment, only the anode electrode 702 is cooled. The anode electrode 702 is shaped in such a way as to optimize the flow of laser gas inside the laser chamber 704. For example, the anode electrode can generally have a surface contour that follows the natural flow of gas through the laser chamber. This flow can include the area near the discharge region between the electrodes, through the heat exchangers, past the fan element and electrostatic filter. The electrode can extend both into the discharge region and into the lower, laser gas portion of the laser chamber. The electrode can serve to ensure that the flow of gas passes substantially through the heat exchangers, and can extend almost down to the fan element in order to minimize turbulence and ensure adequate filtering of the laser gas. The electrode body 702 can have at least one channel 706 through which a cooling medium can flow, which can be located near the discharge area and/or in the lower portion of the gas chamber. In fact, many channels can be provided to enhance control over the cooling of the anode electrode. When the electrode body extends beyond the discharge area 712 and into the lower, laser gas portion of the laser chamber 704, in this example extending almost to the fan element 708, the lower portion of the electrode also can function as an additional heat exchanger for the laser gas, in order to cool the laser gas in the chamber 704. Typically, only a heat exchanger 710 system is used to cool the laser gas. The use of a heat exchanger alone, however, may not provide sufficient heat dissipation for high repetition gas lasers. Additional heat exchangers can be added to the chamber, but such additional elements will tend to alter the gas flow and reduce the overall gas volume in the chamber. Using an extended, cooled electrode to further cool the laser gas can help to provide the necessary heat dissipation for higher repetition operation, without disrupting the flow of gas through the laser chamber.

Another advantage to the design of FIG. 7 is that the amount of electrode consumption or erosion typically is higher for the anode, such that it can be advantageous to cool the anode electrode of the system as shown in FIG. 7, while retaining a level of simplicity by not also cooling the cathode. The cooling medium can be brought into the channel(s) 706 of the anode by tubes (not shown) going to the outside of the laser chamber. Each channel can be connected to a single flow, or each channel can receive a separate flow of cooling fluid. Alternatively, since the temperature of the portion of the anode near the discharge can be most critical, there can be a first flow of cooling liquid directed to at least one channel near the discharge area, with the remaining channels utilizing a separate flow of cooling liquid. It may be advantageous to use different cooling media for these separate flows. It should be understood, however, that it is also possible to cool the cathode in this embodiment, as described above.

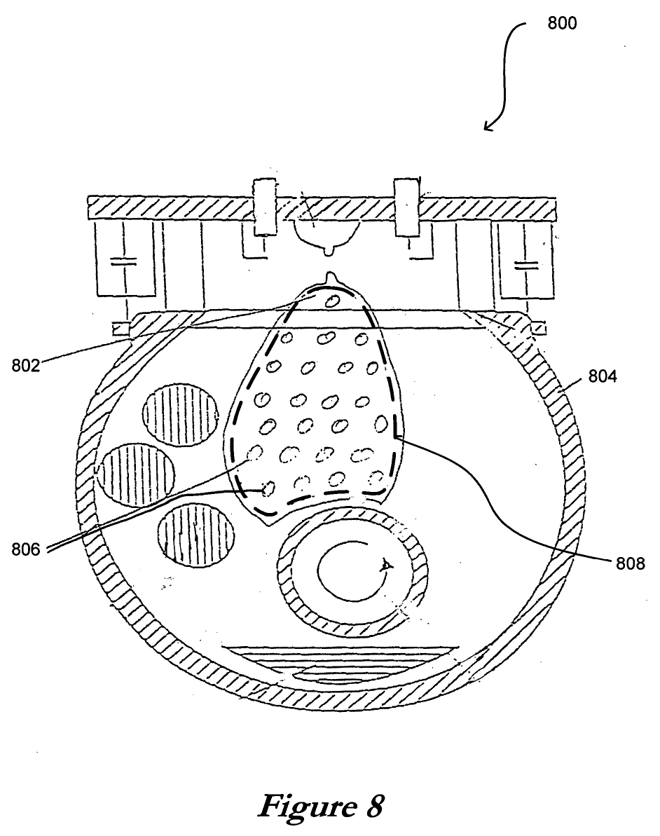

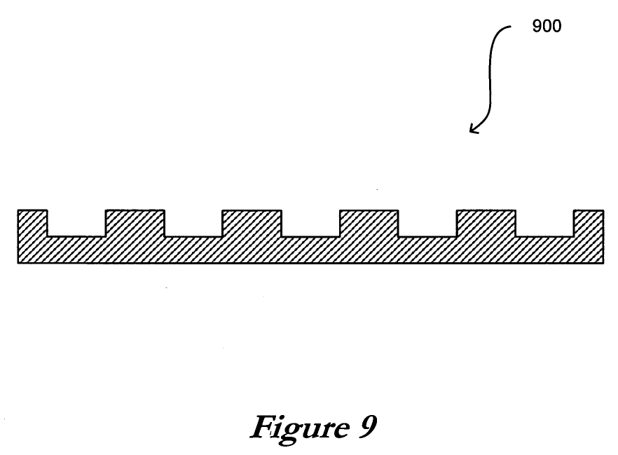

FIG. 8 shows a cooling approach 800 in accordance with a seventh embodiment of the present invention. In this embodiment, only the anode electrode 802 is cooled, and the anode 802 is designed to optimize the flow of laser gas similar to the approach described with respect to FIG. 7. In this embodiment, however, the outer surface of the anode has a fin-like structure 808 designated by the dashed line in the Figure, which corresponds to a surface contour as shown in the cross-section 900 of FIG. 9. Such a fin-like structure can be used over the entire surface of the electrode 802 in order to improve both the flow of laser gas and the amount of heat dissipation from the laser gas, as is known with heat exchange technology. The body of the electrode 802 can have at least one channel 806 through which a cooling medium can flow, such as described with respect to FIG. 7. It should be understood that it is also possible to cool the cathode in this embodiment, as described above.

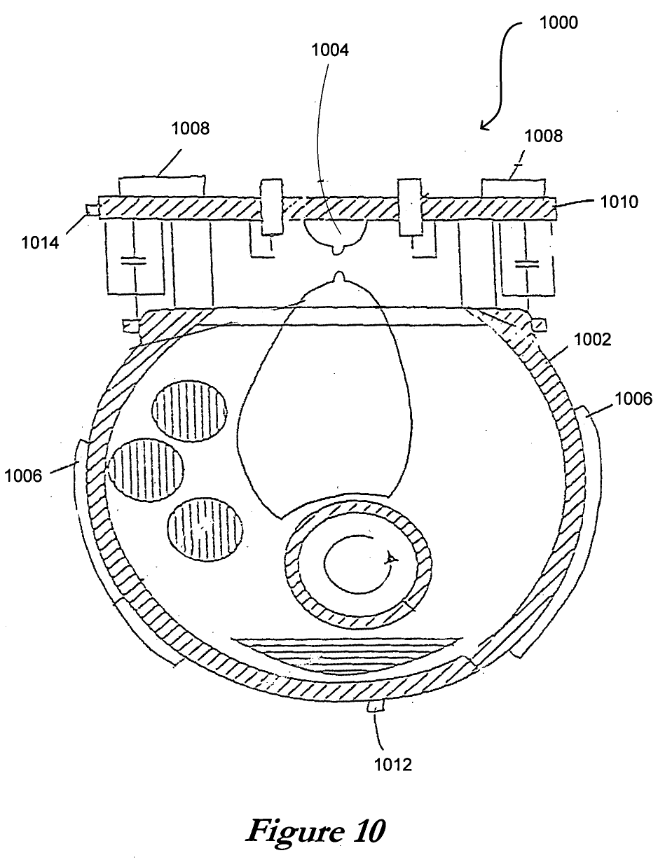

FIG. 10 shows a cooling approach 1000 in accordance with an eighth embodiment of the present invention. In this embodiment, the laser chamber 1002 is cooled in addition to one of the electrodes, here the cathode electrode 1004. The laser chamber 1002 is cooled through use of at least one cooling element 1006 in good thermal contact with the exterior of the laser chamber 1002. It should be understood, however, that cooling elements also can be placed along the inside of the laser chamber, preferably in such a way as to minimize the effect on the flow of gas through the chamber. The cathode 1004 can be cooled through use of at least one cooling element 1008 in good thermal contact with a cathode plate 1010, which is in good thermal contact with the cathode 1004. The temperature of the walls of the laser chamber 1002, as well as the cathode plate 1010, can be monitored by temperature sensors 1012 and 1014, respectively. The temperature sensors used can be any appropriate, commercially available temperature sensors, such as any of the class of PT-100 temperature sensors known in the art. The temperature sensors can provide signals to at least one computer or processing unit for the system (shown as 168 in FIG. 1(b)), which can be used to regulate the temperature by sending a signal to the cooling module to adjust the appropriate cooling elements 1006, 1008. Such an approach also can be used with other approaches described elsewhere herein. For example, either the anode or the cathode, or both, can include fluid channels for circulating a cooling fluid through the respective electrode(s). Also, the anode can have any appropriate shape, such as described with respect to any of FIGS. 3-9.

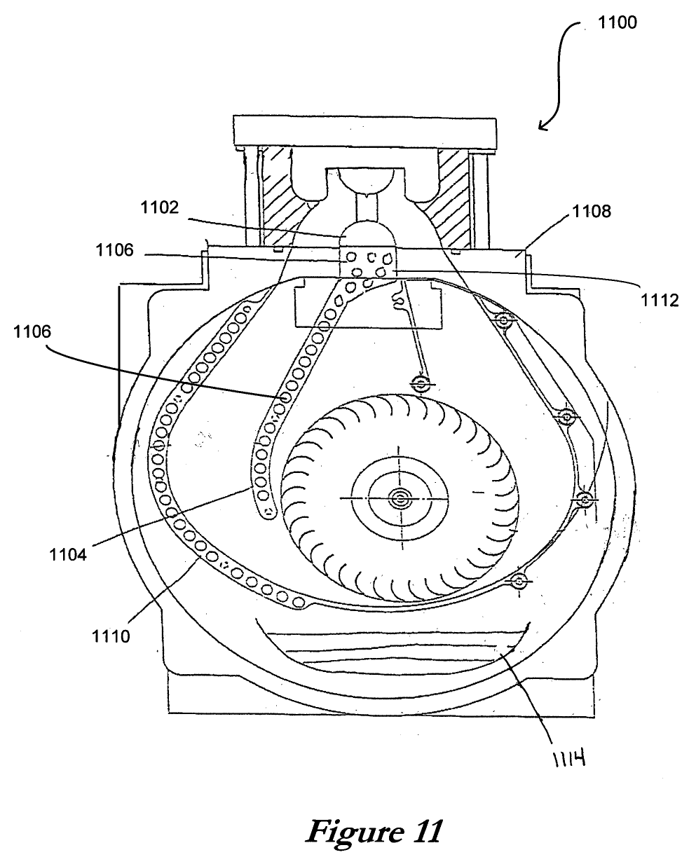

FIG. 11 shows a cooling system 1100 in accordance with a ninth embodiment of the present invention. In this embodiment the anode 1102 is thermally connected to a first cooling plate 1104. The cooling plate can be a single plate or a combination of plates. The cooling plate can have a first portion that contacts the anode, and a second portion that extends into the lower, laser gas portion of the laser chamber. The first cooling plate 1104 can have at least one channel 1106 through which a cooling medium can flow, which can be near the discharge area in order to cool the electrode or in the laser gas portion to act as a heat exchanger for the laser gas, or both. The cooling plate can have a shape which facilitates flow of the laser gas in the laser chamber 1108. For instance, the cooling plate can be shaped to create an aerodynamic pathway to direct the flow of gas in the chamber in order to minimize turbulence in the laser chamber. The first cooling plate also can function to cool the laser gas as the gas flows through the chamber past the cooling plate, such that the typical heat exchanger is not necessary. To further improve the cooling of the laser gas, a second cooling plate 1110 can be utilized in the laser chamber, along the flow of laser gas. The second cooling plate also can be a single element or a combination of elements. The surface of each of the cooling plates 1104, 1110 can have fins as described with respect to FIG. 9, in order to improve the dissipation of heat from the laser gas. Fins on an anode support section 1112 can enlarge the surface area in contact with the laser gas, which can help to improve the amount of cooling. Various fin shapes are possible that are known from commercial heat sinks. Such fins can be up to 20 mm high in one embodiment, and can have a small cross section for a low gas flow resistance. An advantage to such an embodiment is that no heat exchangers are required, such as are shown in the laser chamber of FIG. 1. Removing the heat exchangers not only simplifies the overall system, but also can function to reduce the amount of turbulence in the system that otherwise can be caused by the presence of the heat exchangers. The first and second cooling plates can be shaped to direct gas flow in the chamber, while leaving openings that allow the gas to reach the dust precipitator 1114, for example, and to allow the flow of gas to mix with additional gas in the chamber.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

1. An excimer or molecular fluorine laser system, comprising:
a resonator including therein a laser chamber filled with a laser gas mixture; and
a pair of electrodes for energizing said laser gas mixture in order to generate an optical pulse in the resonator, at least one electrode of said pair of electrodes having disposed therein a channel capable of receiving a flow of cooling medium in order to remove heat from said at least one electrode.

2. A system according to claim 1, further comprising:
a power supply circuit in electrical communication with said pair of electrodes, the power supply circuit providing a driving voltage to said pair of electrodes in order to energize said laser gas mixture.

3. A system according to claim 1, further comprising:
a heat exchanger in the laser chamber for removing heat from said laser gas mixture.

4. A system according to claim 1, further comprising:
a gas circulation fan for circulating the laser gas mixture in the laser chamber.

5. A system according to claim 1, further comprising:
a cooling module unit in fluid communication with the laser chamber for supplying a flow of cooling medium to said channel.

6. A system according to claim 5, further comprising:
tubing connecting said cooling module unit to said channel in order to provide the flow of cooling medium.

7. A system according to claim 1, further comprising:
a media reservoir capable of storing said cooling medium.

8. A system according to claim 1, further comprising:
a heat exchange unit outside the laser chamber for cooling the cooling medium.

9. A system according to claim 1, wherein:
at least one of said pair of electrodes has a shape that extends into a discharge region and into a laser gas region of the laser chamber.

10. A system according to claim 9, wherein
the at least one of said pair of electrodes extends substantially to a gas circulation fan for circulating the laser gas mixture in the laser chamber.

11. A system according to claim 1, wherein:
at least one of said pair of electrodes has a surface including a plurality of fins.

12. A system according to claim 1, wherein:
said cooling medium is a liquid.

13. A system according to claim 1, wherein:
said cooling medium is gaseous.

14. A system according to claim 1, wherein:
said cooling medium is an oil.

15. A system according to claim 1, wherein:
said cooling medium is water.

16. A system according to claim 1, wherein:
said cooling medium is at a temperature in the range of 30-120° C.

17. A system according to claim 1, wherein:
said flow of cooling medium is directed through the channel when the laser system is operated at a repetition rate of at least 4 kHz.

18. An excimer or molecular fluorine laser system, comprising:
a resonator including therein a laser chamber filled with a laser gas mixture;
a pair of electrodes for energizing said laser gas mixture in order to generate an optical pulse in the resonator; and
a cooling element in thermal contact with at least one electrode of said pair of electrodes, the cooling element capable of removing heat from said at least one electrode.

19. A system according to claim 18, further comprising:
an electrode plate positioned between the cooling element and the at least one electrode in order to provide said thermal contact.

20. A system according to claim 18, wherein:
the cooling element is located outside the laser chamber.

21. A system according to claim 18, wherein:
the cooling element has at least one channel disposed therein for receiving a flow of a cooling medium in order to remove heat from the cooling element.

22. A system according to claim 18, further comprising:
a temperature sensor in thermal contact with the at least one electrode.

23. A system according to claim 22, further comprising:
a cooling module capable of receiving a temperature signal from the temperature sensor and controlling a heat removal capacity of the cooling element in response to the temperature signal.

24. A system according to claim 18, further comprising:
a power supply circuit in electrical communication with said pair of electrodes, the power supply circuit providing a driving voltage to said pair of electrodes in order to energize said laser gas mixture.

25. A system according to claim 18, further comprising:
a heat exchanger in the laser chamber for removing heat from said laser gas mixture.

26. A system according to claim 18, further comprising:
a gas circulation fan for circulating the laser gas mixture in the laser chamber.

27. A system according to claim 23, further comprising:
tubing connecting said cooling module unit to said channel in order to provide the flow of cooling medium.

28. A system according to claim 18, further comprising:
a media reservoir for storing said cooling medium.

29. A system according to claim 18, further comprising:
a heat exchange unit outside the laser chamber for cooling the cooling medium.

30. A system according to claim 18, wherein:
the cooling element is located in a laser gas region of the laser chamber and extends substantially toward a cooling fan element in the laser gas region.

31. A system according to claim 18, wherein:
said cooling element is disposed inside the laser chamber.

32. A system according to claim 31, wherein:
the cooling element is shaped to direct a flow of the laser gas mixture past heat exchange elements located in the laser gas region.

33. A system according to claim 31, wherein:
said cooling element has a surface that includes a plurality of fins.

34. A system according to claim 18, wherein:
said cooling medium is selected from the group consisting of liquids, gases, and oils.

35. An excimer or molecular fluorine laser system, comprising:
a resonator including therein a laser chamber filled with a laser gas mixture;
a pair of electrodes for energizing said laser gas mixture in order to generate an optical pulse in the resonator, at least one electrode of said pair of electrodes having disposed therein a channel capable of receiving a flow of cooling medium in order to remove heat from said at least one electrode;
a temperature sensor in thermal contact with the at least one electrode and capable of generating a temperature signal; and
a cooling module for providing the flow of cooling medium, the cooling module capable controlling the flow of cooling medium through the channel in response to the temperature signal in order to regulate a temperature of the at least one electrode.

36. A system according to claim 35, further comprising:
a power supply circuit in electrical communication with said pair of electrodes, the power supply circuit providing a driving voltage to said pair of electrodes in order to energize said laser gas mixture.

37. A system according to claim 35, further comprising:
a heat exchanger in the laser chamber for removing heat from said laser gas mixture.

38. A system according to claim 35, further comprising:
a gas circulation fan for circulating the laser gas mixture in the laser chamber.

39. A system according to claim 35, further comprising:
tubing connecting said cooling module to said channel in order to provide the flow of cooling medium.

40. A system according to claim 35, further comprising:
a media reservoir for storing said cooling medium.

41. A system according to claim 35, further comprising:
a heat exchange unit outside the laser chamber for cooling the cooling medium.

42. A system according to claim 35, wherein:
said cooling medium is selected from the group consisting of liquids, gases, and oils.

43. A system according to claim 35, wherein:
the at least one electrode has a surface including a plurality of fins.
